(19) United States
(12) Patent Application Publication
(10) Pub. No.: US 2024/0264397 A1
(43) Pub. Date: Aug. 8, 2024

(54) OPTICAL FIBER PROTECTIVE COMPOSITE COATING

(71) Applicant: Mehdi Ravanbakhsh, Tehran (IR)

(72) Inventor: Mehdi Ravanbakhsh, Tehran (IR)

(21) Appl. No.: 18/639,009

(22) Filed: Apr. 18, 2024

Related U.S. Application Data
(63) Continuation-in-part of application No. 17/627,443, filed on Jan. 14, 2022, now abandoned.

(30) Foreign Application Priority Data
Jul. 23, 2020 (WO) PCT/IR2020/050023

(51) Int. Cl. G02B 6/44; B29D 11/00; B29K 33/00; B29K 83/00; B29K 105/08; B29K 277/00; B29K 307/04; B29K 309/08

(52) U.S. Cl. CPC G02B 6/443; B29D 11/00663; G02B 6/4486; B29K 2033/00; B29K 2083/005; B29K 2105/08; B29K 2277/10; B29K 2307/04; B29K 2309/08

(57) ABSTRACT

The present invention is an optical fiber unit (cable) made from a coated optical fiber with UV-curable resin that is integrated into a cross-section of Fiber-reinforced polymer (FRP) composite to provide more mechanical protection for the optical fiber. In the first stage, the optical fiber is covered with a coating of acrylic or silicon UV-curable resin, and then all or a part of the cross-section of the optical fiber is placed in a fiber-reinforced polymer (FRP) that is cured by UV in Pultrusion process. Then, the composition is covered by thermoplastic polymers. At least one optical fiber is regularly located on the cross-section or outer surface of an FRP in such a way that all or part of the cross-section of the optical fiber is placed in the cross-section of FRP cross-section.

### CROSS-REFERENCE TO RELATED APPLICATIONS

This application is a continuation-in-part of U.S. application Ser. No. 17/627,443 filed on Jan. 14, 2022. The application is incorporated herein by reference in its entirely.

### FIELD OF THE INVENTION

The present invention relates in general to the optical fiber unit (cable) for air blown installation or Drop cable for wall mount or aerial Installation and in particular, to a new protecting method for optical fiber by composition in which the optical fiber is integrated in FRP (Fiber Reinforced polymer) or (located in the cross section of (FRP).

### BACKGROUND OF THE INVENTION

Coated optical fibers are widely used in the communications field because of their ability to carry large amounts of information over long distances. As shown in FIG. 1A (Prior art) each fiber optic cable consists of a number of optical fibers (Optical Fiber Core) which is covered in the last layer with a protective coating of colored acrylic or colored silicone (coating) so that the diameter of each fiber reaches 180 to 250 microns. In the next step, several protective coating layers are placed in such a way as to protect the optical fibers from physical effects (mechanical, temperature, and humidity).

There have been two major categories of fiber optic shielding. In the first type, which is called Loose-Tube, as shown in FIG. 1B (Prior art), 1 to 24 optical fibers with anti-moisture (water blocking system) and anti-freeze gel are placed in a plastic tube (PBT, Polyamide, PVC), these tubes are called Loose-Tube. 1 to 12 Loose-Tube with other physical strengthening elements such as Aramid Yarn (strength element) and FRP as central strength member are used to strengthen the elastic state of the cable and increase the tensile strength of the cable.

In the second type, which is called Tight-Buffer, as shown in FIG. 1C (Prior art) each of the optical fibers is covered separately with a layer of plastic (PVC, Polyamide, Polyurethane, Polyethylene) with a thickness of approximately 325 microns so each tight buffer element has a 900-micron diameter. In the next step, 1 to 24 strands of Tight-Buffer coating are not categorized or categorized in batches of 1 to 24 with other physical strengthening elements such as aramid fibers to increase the tensile strength of the cable. Non-metallic intermediate (composite) (FRP) to strengthen the elastic state of the cable and increase the tensile strength of the cable along with other protective components such as water-blocking yarn to prevent water from spreading in the cable in one or more sheaths Made of plastic (PVC, Polyamide, Polyurethane, Polyethylene) or in some layers in a cover of metal sheaths to protect the fiber optic fiber against the mechanical and temperature effects of the environment used.

Using different elements in different parts of the cable, each of which has a separate role, such as aramid fibers, FRP as central strength member, moisture-proof tape, independent protective covers for each optical fiber in various types of Tight-Buffer cables, and protective tube with antifreeze gel in all types of Loose-Tube cables has drawbacks. These components do not fit perfectly together with geometric shapes, eventually the diameter of the final cable increases according to the required mechanical and temperature resistance, and this increase in diameter is also effective on the following factors:
a. Decreased optical fiber density relative to cable cross-section.
b. Cable costs will increase due to the use of different elements as well as due to the increase in process steps related to cable production.
c. Increase the cost of transportation and maintenance during storage and during the installation of cable.
d. Costs related to executive operations also increase according to the following parameters:

The cost of goods related to cable installation is greatly increased in executive projects for the installation of optical cables such as ducts and micro ducts. Costs related to ground drilling, overwork and rehabilitation of drilled land increase due to the increase in duct diameter. The cost of municipal fines increases with increasing drilling width. Increasing the weight and volume of the cable as well as increasing the volume of excavation drastically reduces the speed of the operation. Due to the increase in the weight of the unit length and also the increase in the diameter of the cable, there is a great limitation regarding the number and capacity of aerial cables that can be installed on the transmission and lighting beams.

Due to the mentioned problems regarding the low number of optical fibers in optical cables in relation to the high diameter of the cable, a new subset of Tight-Buffer cables called ribbon cables was developed.

In Tight-Buffer cables, each fiber was covered separately with a polymer (plastic) coating as a separate optical fiber, but in Ribbon cables, as shown in FIG. 1D (prior art), 4 to 12 strands of optical fiber that are glued together horizontally (strip) are covered with a polymer coating.

FIG. 1H shows the high-capacity circular ribbon cable 200 and the part of the cable. In a ribbon cable a plurality of 4 to 12 optical fibers covered with colored acrylic resin are placed next to each other in a row and are connected by a UV-cured resin. The bonding quality and adhesive strength of this type of resin are such that it is easy to separate the optical fibers. A certain number of these optical fiber ribbons are placed on top of each other to create a regular cross-section of optical fiber 210, and each layer is connected to the other layers by a resin with less adhesion. Thereby, the ribbon layers can be easily separated when needed.

The optical fiber is grouped in the form of a regular cross-section, and a layer of ribbons is placed in the cable protection structure and protected by various elements such as waterproof tape 220, FRP 250, plastic regulatory structures 230, final outer jacket 240 and ripcord 260 for easy outer jacket separation. In this type of cable, a plurality of elements are provided to protect the optical fiber, which makes the production process very complicated and includes a large volume of the cross-section of the cable. The final weight of the optical cable is extremely high.

Ribbon cable design has reduced the cross-sectional area of optical cables to a very limited extent, but this design has faced limitations and shortcomings. Due to the limited and predetermined shape of each ribbon, in practice in single-strip cables, the geometric shape of the cable cross-section is not circular, and this deformation prevents the use of this cable in ducts or aerial installation. if the shape of the cross-section of the cable changes to a circle large space of the cable remains unused. Almost all the previous elements of Tight-Buffer cables such as plastic sheath, FRP, aramid fibers, and moisture-proof tape are also present in Ribbon cables, which eventually lead to an increase in cable diameter, price, and weight.

To protect the fibers from physical damage during installation and also to protect from the physical and chemical effects of the installation environment, it is conventional to apply protective coatings to the freshly drawn fibers part of the optical cable production process. The normal method of installation is direct cable installation in the ground or aerial installation that involves pulling the fibers along previously laid cable ducts with the aid of ropes in this method to avoid damage, it is necessary to cover jacket the fibers with an expensive material.

To avoid these problems, it has been proposed in EP0108590 to propel the fiber along a tubular pathway by the fluid drag of a gaseous medium passed through the pathway in the desired direction in advance. In other words, the fibers, usually in sheathed multiple bundles, are blown into place on a cushion of air. By using this technique, it is possible to “blow” optical fiber cable along micro ducts for long distances (several kilometers) without damage.

Fibers suitable for blowing require packaging which is cheaper and simpler than normal cable structure. A number of designs are known; in EP0521710A1, EP0296836A1, U.S. Pat. Nos. 5,555,335, 7,397,990, 7,623,748, 5,533,164. These patents disclose optical blowing cables try to fit more optical fibers in less space and provide more physical protection for them. In the first step the optical fibers are surrounded by UV-curable (silicone-acrylate) resin to protect the optical fiber, and after that, they use another type of UV-curable resin or thermoplastic polymer to cover, integrate, and make more protection in each layer and finally try to design a new structure that helps blowing performance.

Based on the listed prior art in the previous section and all other similar patents, the use of thermoplastic polymers and resin polymers as optical fiber protection alone, is not able to create a cable resistant to all mechanical pressures. The cable produced according to the third method, despite the reduction in diameter and increase in the density of optical fibers in the cross-sectional area, is too sensitive and non-resistant, and the operational implementation of such cables in executive projects faces many problems.

### SUMMARY OF THE INVENTION

The present invention aims to provide enhanced mechanical protection for optical fibers in optical cable manufacturing. The process involves multiple stages, each contributing to the overall protection and durability of the optical fibers. In the initial stage, each optical fiber undergoes a coating process with UV-curable resin, a common practice in previous patents. This coating results in an outer diameter for each optical fiber ranging from 180 to 250 microns.

Moving to the second stage, a fiber-reinforced resin (FRP) is applied to all or part of the cross-section of the optical fiber. The curing of this FRP is achieved through a UV Pultrusion process. This innovative step introduces a composite material that surpasses the mechanical properties of conventional resin-only materials, providing superior protection for the optical fiber.

In the third and final stage, the composition created in the second stage is further safeguarded by covering it with plastic polymers such as PVC, Polyamide, Polyurethane, Polyethylene, or any other suitable plastic material. In this process, optical fibers initially receive a protective layer of colored UV-curable (silicone-acrylate) resin. Unlike conventional methods, at least one optical fiber is strategically placed on the cross-section or outer surface of an FRP cylindrical shape (or any other geometric or non-geometric shape) during the Pultrusion process. This ensures that all or part of the optical fiber's cross-section is embedded within the FRP cross-section.

Contrary to traditional practices involving just curable resin or thermoplastic polymer as second and third layer protection (EPFU), this innovation employs a method where 1 to 24 optical fibers are collectively covered with colored acrylic, colored silicone coating, or any other similar protective coating. These optical fibers are situated on the cross-section or outer surface of an FRP cross-section, created through the Pultrusion process.

The diameter of the FRP cylindrical shape can range in various diameters. Each FRP, housing the optical fibers, is termed an optical composite unit (OCU). These units are then coated with a plastic layer. The units can be coated with multilayers of thermoplastic polymer. Although some units may remain uncoated.

Multiple optical composite units can be arranged next to each other, forming an optical cable with varying capacities. Each optical composite unit's dimensions and cross-sectional shape can be tailored to any geometric or non-geometric form, ensuring the absence of empty spaces between units in the cable. The placement and number of optical fibers within each unit can be adjusted according to specific application requirements and mechanical resistance parameters.

In instances where optical fiber connections are necessary, the reinforced fiber can be separated, breaking the FRP structure. This action makes the optical fibers accessible for stripping and fusion processes.

Therefore, it is an object of the present invention to use fiber-reinforced resin polymer instead of resin or thermoplastic polymer alone or resin combined with particles to cover the optical fiber.

It is another object of the present invention to provide an improved structure for the optical fiber unit (cable) that is suitable for blowing and use as drop wire(cable) in the FTTX network and improved resistance to fiber break-out.

It is another object of the present invention that in comparison with conventional cables more optical fibers are placed in the same cross-section, thereby the density of optical fibers in the cross-section of the cable will be increased significantly and reduce the diameter of optical cables while maintaining a large capacity, which will reduce the cost of running optical cable installation projects many times over.

It is another object of the present invention that since a very high percentage of the cable cross-section is FRP, it provides higher protection for the optical fiber and greatly increases the parameters of mechanical strength, temperature resistance, and moisture resistance of the optical cable.

It is another object of the present invention to reduce the cost of producing fiber optic cable by reducing raw materials consumption, removal of many elements that are used in conventional cables, and reducing the number of production processes.

It is another object of the present invention to use fiber-reinforced UV-curable resin instead of thermoset resin and thereby, remove the need of special heat protection layer for optical fiber and increase the production speed significantly.

### BRIEF DESCRIPTION OF DRAWINGS

Embodiments herein will hereinafter be described in conjunction with the appended drawings provided to illustrate and not to limit the scope of the claims, wherein like designations denote like elements, and in which:

FIG. 1A shows a fiber optic with one layer color acrylic coating;

FIG. 1B shows a Loose-Tube cable structure;

FIG. 1C shows a Tight-Buffer cable structure;

FIG. 1D shows a Tight-Buffer cable structure;

FIG. 1E shows a simple circular ribbon cable structure;

FIG. 1F shows a fiber ribbon cable;

FIG. 1G show EPFU cable structure;

FIG. 1H shows a high-capacity circular ribbon cable and the part of the cable;

FIG. 2A is a perspective view of an optical fiber unit, according to the present invention;

FIG. 2B is a cross-sectional view of an optical composite unit in which all the cross-section of the optical fiber is placed in a fiber-reinforced polymer (FRP).

FIG. 2C is a cross-sectional view of an optical cable unit according to FIG. 2B;

FIG. 3A is a perspective view of an Optical Fiber Unit in which a part of the cross-section of the optical fiber is placed in a fiber-reinforced polymer (FRP);

FIG. 3B is a cross-sectional view of an Optical Fiber composite in which a part of the cross-section of the optical fiber is placed in a fiber-reinforced polymer (FRP);

FIG. 3C is a cross-sectional view of an optical cable unit according to FIG. 3B;

FIG. 4A shows an optical fiber unit with seven OCU in which a part of the cross-section of the optical fibers is placed in fiber-reinforced resin(FRP);

FIG. 4B shows an FRP component, structure, layer, and material;

FIG. 5 FRP production process diagram for continuous fiber named pultrusion;

FIG. 6 shows a loose tube optical fiber cable and the protective components according to the present invention, and

FIG. 7 is another embodiment of the present invention showing an optical cable that contains one optical composite unit by flat FRP cross-section;

### DETAILED DESCRIPTION OF THE INVENTION

Fiber optic cables are normally produced with low fiber optical core density to cable cross-section ratio especially in low-capacity cable for 1 to 24 cores. These cables have high cable cross-section and high cable weight when a high mechanical performance for cable is required. These cables have a high-cost multi-stage and intensive production process, a high cost of installation based on the size of cable diameter, and a high cost of installation based on the weight and high volume of the cable.

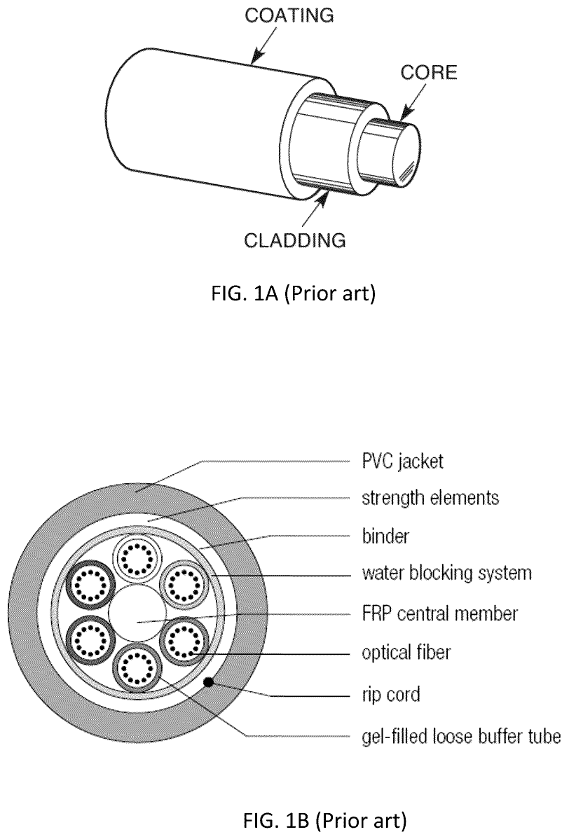

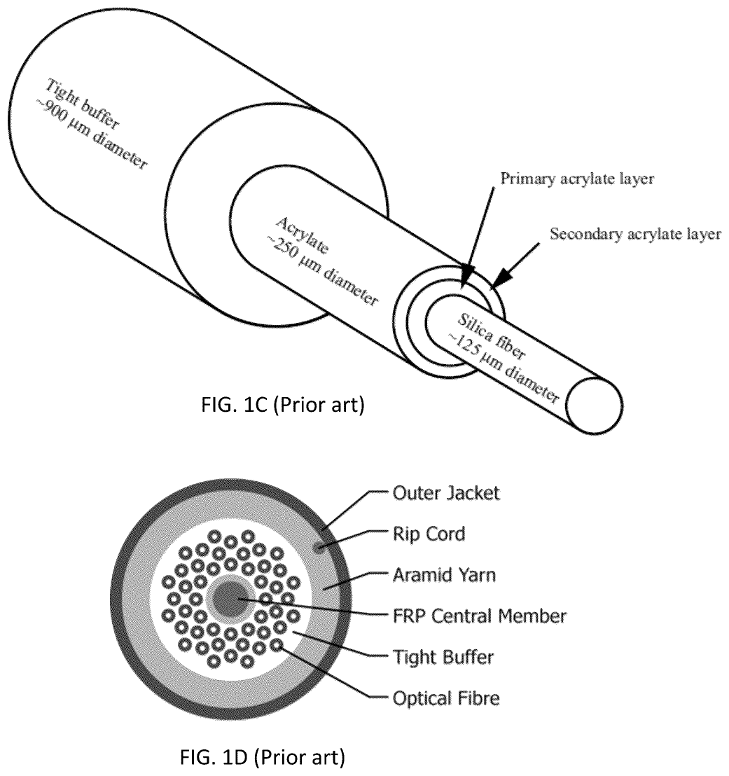

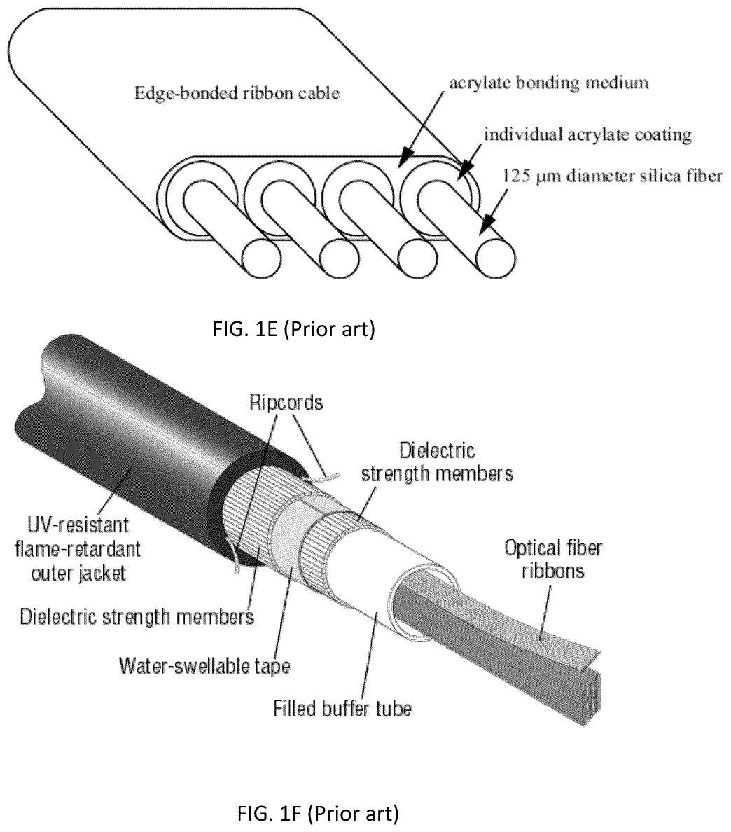

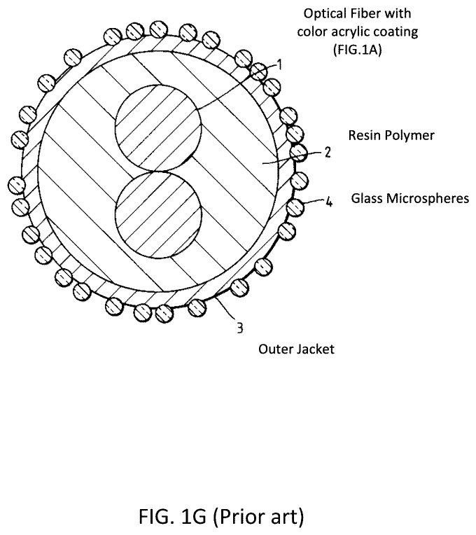

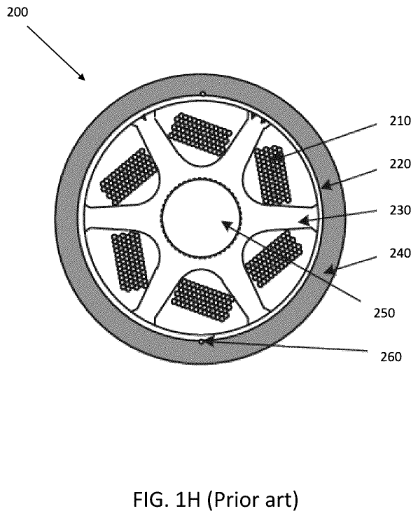

To solve these problems the EPFU (Enhanced Performance Fiber Unit) optical cable was invented (FIG. 1E). However, with a careful examination of the specifications, materials, and components of this type of cable, it is clear that the cable produced from this structure has a very low physical resistance, so the cable produced has very weak physical parameters, especially in the three main parameters: crash resistance, tensile strength resistance (Young's modulus) and impact resistance. The reason for this problem is the removal of parts of the usual optical fiber cables, among which can be mention the removal of FRP as the central strange member in the structure of the optical cable which strengthens Young's modulus and increases the tensile strain resistance in the optical cable.

To achieve a perfect structure with high physical resistance parameters and a high fiber density, the present invention uses a type of raw material that simultaneously protects the optical fiber and creates a suitable mechanical strength for the cable. The present invention uses composite materials instead of the usual polymers that have low weight and very high mechanical strength. Location and geometric dimensions of different parts of the cable should be such that there is at least unusable space between the components of the cable. The production process should be simple so that the cable is fully produced in one stage of production. The structural components of each unit of the present invention comprise:
1. Plastic outer cover (PVC, Polyamide, Polyurethane, Polyethylene);
2. FRP composite. (Fiber Reinforcement Polymer), and
3. Optical fiber with colored acrylic coating with a diameter of 180 to 250 microns.

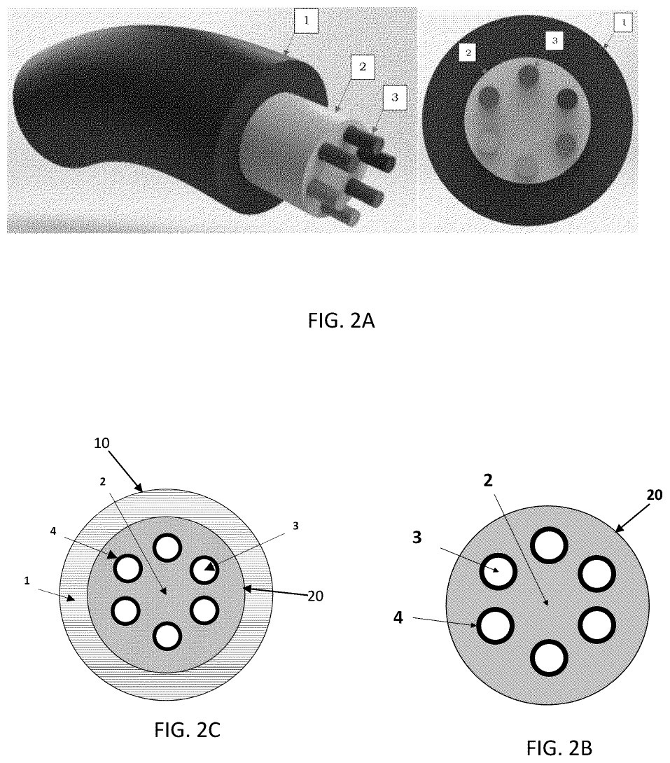

FIGS. 2A to 2C show an Optical fiber unit 10 in which all the cross-section of optical fiber 3 is placed in a fiber-reinforcement resin(FRP) 2. The Optical Composite Unit 20 has a plastic coating 1 to create optical fiber unit 10 and the Optical Fiber 3 is coated with colored acrylic silicone 4. In the first stage, the optical fiber 3 is covered with a coating of colored UV curable resin 4, so that the outer diameter of each optical fiber 3 reaches 180-250 microns or more depending on the type of optical fiber and mechanical property that is needed for coated optical fiber. In FIG. 2C a cross-sectional view of an optical composite unit 20 is shown in which all the cross-sections of the optical fibers 3 are placed in a fiber-reinforced resin (FRP) 2.

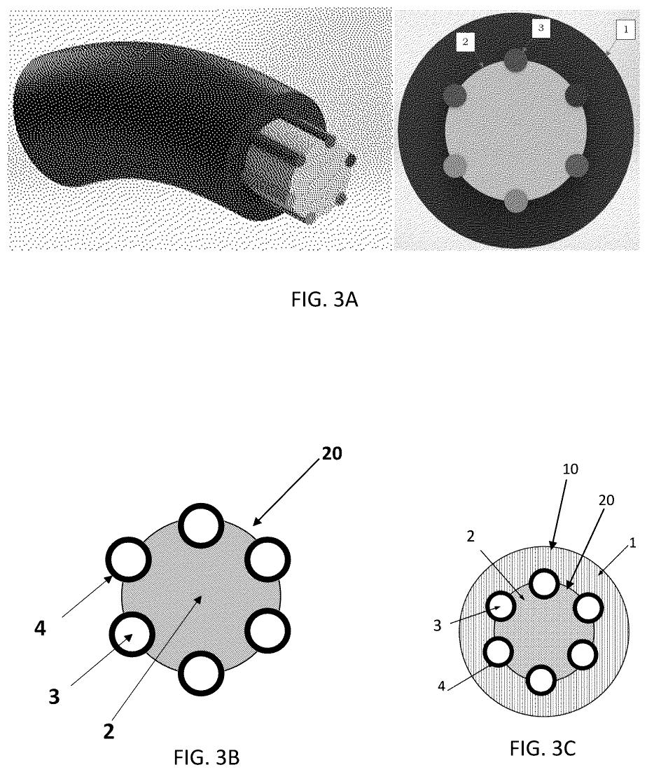

FIGS. 3A to 3C show an Optical fiber Unit 10 in which a part of the cross-section of the optical fiber 3 is placed in a fiber-reinforced resin (FRP) 2. FIG. 3B shows an Optical composite unit (OCU) 20 in which a part of the cross-section of the optical fiber is placed in a fiber-reinforced resin (FRP) 2. FIG. 3C shows an optical fiber unit 10 with six optical fibers 3 in which a part of the cross-section of the optical fiber is placed in fiber-reinforced polymer (FRP).

In this method, at least one optical fiber 3 in the first stage is located on the cross-section or outer surface of a cylindrical shape that is made of FRP composite (Fiber Reinforcement polymer) 2 in a way that all or part of the optical fibers 3 are placed in the cross-section of FRP cross-section.

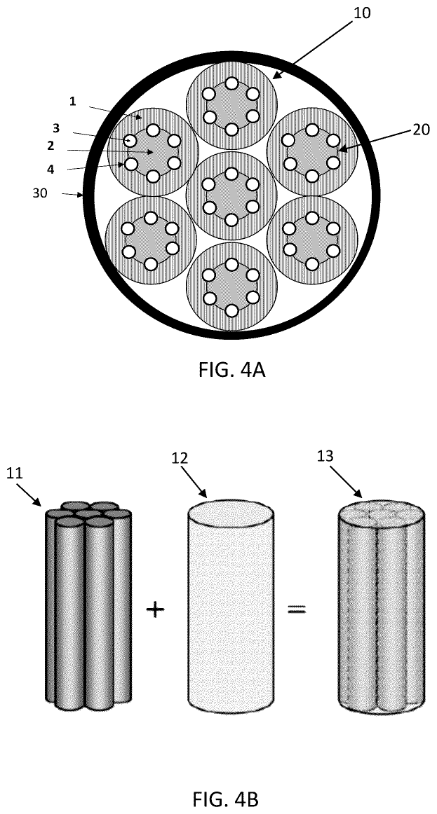

FIG. 4A shows an optical fiber unit 10 with seven OCU 20 in which a part of the cross-section of the optical fibers 3 is placed in fiber reinforced polymer (FRP) 2 and each OCU coated by polymer 1 and all coated OCU are finally covered in another polymer cover 30.

According to FIG. 4B the FRP composite consists of two main components: Fibers 11 which typically include continuous fibers of glass, aramid, basalt, carbon, nylon, or natural fibers such as knauf, and Resin 12 which combines with the fibers in a liquid form and deforms into a solid in a chemical process, eventually leading to the integration and bonding of the fibers. The composite material consists of two main parts, the resin which is known as matrix 12, and the reinforcement fiber 11. This combination of components creates a FRP material 13 that has completely different mechanical specifications from the raw materials. A wide range of resins can be used that can be cured by UV and can be used for FRP production such as Vinyl Ester, Polyester, Epoxy, etc. depending on the mechanical property that is needed for FRP. A wide range of reinforced fiber types and sizes (of filament), such as glass fiber, basalt, etc. can further be used depending on the mechanical property needed for FRP.

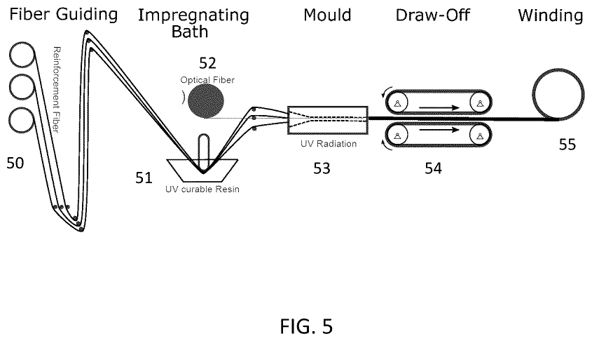

According to FIG. 5, the invention introduces a pultrusion production line for Fiber-Reinforced Polymer (FRP). The Pultrusion process for this specific type of optical composite unit involves several key stages. In the initial stage, continuous direct roving of reinforced fiber 50 undergoes impregnation in a resin bath 51. Subsequently, in the second step, the reinforcing fibers, impregnated with resin, and the optical fiber 52 (previously coated with colored silicone acrylate resin in the first stage) are inserted into the forming mold 53 and exposed to UV radiation. Following the resin curing process, the physical structure of the FRP is established, with the optical fiber positioned on the cross-section of the FRP. Ultimately, the Optical Composite Unit (OCU) emerges from the mold. The capstan machine 54 is responsible for the movement of the entire material in the production line and pulls the final product out of the mold at a controlled speed so that the optical fibers and reinforced fiber can go through the entire process to the pultrusion mold at a certain speed. The winding machine 55 at the end of the production line has the task of collecting the product produced on the reel, and the OCU produced on the reel is collected at the end of the production line.

The configuration of the FRP cross-section, along with the positioning of the optical fibers coated with silicone-acrylic resin within the FRP cross-section, is dictated by the forming mold. The FRP can assume a geometric or non-geometric cross-section in any desired shape. This flexibility allows for the alteration of the cross-section shape and dimensions, enabling the creation of varied mechanical characteristics for the optical fiber unit. The composite generated after the second stage of production is termed the Optical Composite Unit (OCU).

The optical composite unit (OCU) is coated with a layer of polymers like PVC, Polyamide, Polyurethane, Polyethylene, or any other thermoplastic by extrusion process. The thickness and type of polymer that is used are related to the mechanical properties that are needed for the optical fiber cable. The number of Optical Composite Units (OCUs) coated with polymer coating depends on the required capacity and mechanical characteristics of the produced optical fiber unit (cable). In most cases, just one OCU with thermoplastic polymer coating can be used as a simple and low-diameter micro-optical cable for air-blowing installation. When a portion of the cross-section of the coated optical fiber is positioned in the cross-sectional area of the FRP, the coated optical fibers can be manually peeled away from an element without fracturing the FRP structure. However, if the entire cross-section of the optical fiber is situated in the cross-sectional area of the FRP, it becomes necessary to fracture the FRP structure to access the optical fiber.

In contrast to traditional methods, at least one optical fiber is strategically placed on the cross-section or outer surface of a cylindrical shape FRP (or any other geometric or non-geometric shape) during the Pultrusion process. This placement ensures that all or part of the optical fiber's cross-section is embedded within the FRP cross-section.

Contrary to traditional practices involving individual plastic coverings for each optical fiber (Tight-Buffer), this innovation employs a method where 1 to 24 optical fibers are collectively covered with colored acrylic, colored silicone coating, or any other protective coating are situated on the cross-section or outer surface of an FRP cross-section, created through the Pultrusion process.

The diameter of the FRP cylindrical shape can be in various range. Each FRP, housing the optical fibers, is termed an optical composite unit (OCU). These units are then coated with a plastic layer with a thickness. Although some units may remain uncoated.

Multiple optical composite units can be arranged next to each other, forming an optical cable with varying capacities. Each optical composite unit's dimensions and cross-sectional shape can be tailored to any geometric or non-geometric form, ensuring the absence of empty spaces between units in the cable. The placement and number of optical fibers within each unit can be adjusted according to specific application requirements and mechanical resistance parameters.

The combination of FRP and fiber optics has a very similar homogeneity and physical composition. As a result of this integration, the force due to compression, bending, and tension is spread evenly over the cross-sectional area, and the length of the cable reduces its point effect to a minimum and ultimately leads to a lack of stress concentration at one point. Thereby, force is distributed at all levels of each optical composite unit. This will eventually lead to a very high increase in cable physical endurance.

In another embodiment to create optical cables with more capacities, 1 to 24 (or more) composite units are placed next to each other without the need for other physical reinforcing elements that are normally used in optical cables and finally covered with plastic with or without metal sheath.

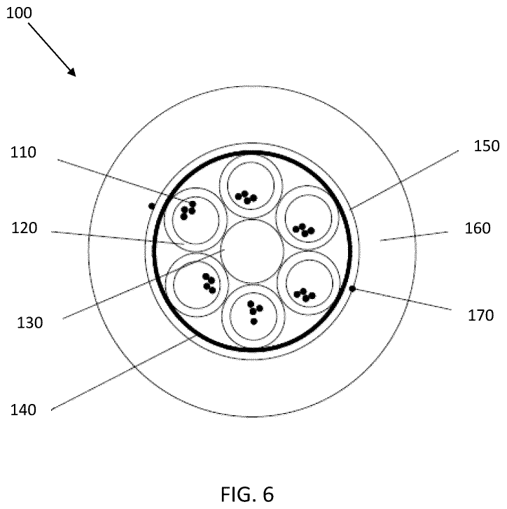

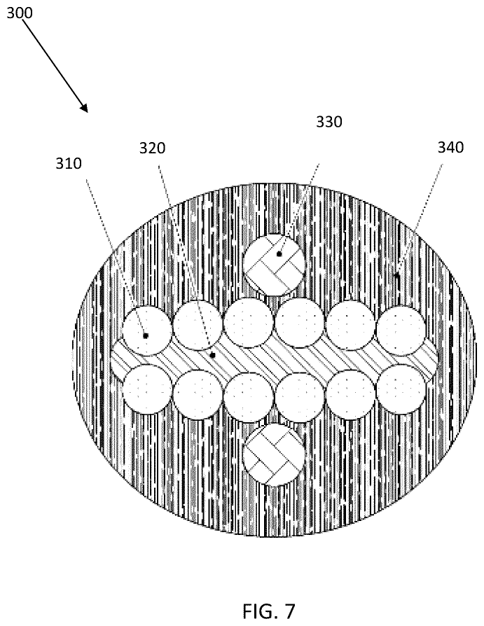

FIG. 6 shows another embodiment of the present invention in loose tube optical fiber cable 100 and its protective components. The cable comprises an acrylate-coated optical fiber 110. The maximum amount of cross-section area of the loose-tube 120 is filled with gel. The cable provides an FRP 130 as central strength member. For increasing the cable tensile strength and more Young modules a first HDPE cover for the first protection layer 150 and a second HDPE cover for the second layer 160 with an aramid yarn 140 is provided to cover the cable. The last polymer coating 160 covers the most cross-sections of optical cable and provides more mechanical protection. The ripcord 170 is a parallel cord of strong yarn that is situated under the jacket(s) of the cable for jacket removal that is needed for removing a very thick jacket layer. A plurality of individual elements are needed to create a strong mechanical property for loose-tube cable.

A larger number of optical fibers compared to Tight-Buffer cables as well as Loose-Tube cables have been placed in the same cross-sectional area to significantly increase the density of optical fibers in the cross-sectional area of the cable. These cables reduce the diameter of optical cables while maintaining a large capacity, which will reduce the cost of running optical cable installation projects. The cable cross-section's substantial composition of Fiber-Reinforced Polymer (FRP), characterized by its outstanding physical properties often surpassing those of metals, yields superior advantages compared to other plastics utilized in Tight-Buffer and loose-tube configurations. The present invention provides more optical fiber in less diameter by the same mechanical property that is used in the traditional optical cables.

FIG. 7 shows an optical cable that contains one optical composite unit by flat FRP cross-section 300. There is a cross-sectional surface of an optical cable unit that is designed and manufactured based on the proposed innovation. In this cable, more than half of the cross-sectional surface of the optical fiber is covered with UV curing resin 310 and placed in cross-section of FRP 320 in the pultrusion process. the FRP 320 has an oval cross-sectional shape and this composition creates an optical composite unit (OCU). The optical composite unit is covered by a HDPE cover 340 in the extrusion process. Two rip cords 330 have been used in this design to make it possible to separate the outer shell.

In the present invention, the coating significantly enhances the protection of the optical fiber and elevates the mechanical strength, temperature resistance, and moisture resistance parameters of the optical cable, resulting in the following benefits which have been approved by experimentations:
Enhanced resistance to pressure shocks (Impact) due to the utilization of FRP instead of PBT loose tube in Loose-Tube cables and PVC fiber optic covers in Tight-Buffer cables.
Increased tensile strength facilitated by the remarkable tensile strength of FRP (approximately 1000 to 1500 MPa), further amplified by the extensive use of FRP in the cable cross-section, resulting in a notably robust cable.
Superior resistance to corrosive shocks (Crush Resistance) is achieved through the FRP's high surface hardness (shore D Barcol 935) and exceptionally high elastic modulus, preventing deformation.
Enhanced resistance to successive bends (Repeated Bending) facilitated by the very high modulus of elasticity of FRP (approximately 50 GB young modulus).
Improved resistance to cable torsion due to the high flexibility of FRP (flexibility module close to 50 GPA).
Reduction in the allowable radius of curvature of the cable (Cable Bend) resulting from the decreased cable diameter, positively impacting transportation and installation operations.
Reduction of the minimum loop diameter at the onset of the kinking of an optical fiber cable, enabled by the high flexibility of FRP and good young module.
Expansion of the cable's resistance range to high and low-temperature changes due to the fully adhesive FRP coating, ensuring the optical fiber's protection under varying temperature conditions.
The increased elasticity modulus of the cable, preventing cable bending beyond the minimum allowable radius of curvature, avoiding cable ties during coil opening, preventing cable twisting during coil opening, and allowing for rearrangement and rewinding without cable damage during installation and operation.

The current invention extends the range of air-blowing Fiber cable over long distances in both ground and aerial micro-ducts. The substantial FRP content in each composite unit, occupying a large percentage of the cable's total cross-section, endows the produced cable with exceptionally high elasticity, significantly enhancing the cable's ability to navigate through ducts and micro-ducts.

This cable manufacturing method reduces cable diameter by eliminating elements utilized in conventional cables to increase physical strength or resistance to water penetration. In this cable, the use of FRP wire covering units negates the need for a composite non-metallic intermediate element (FRP) to provide elastic properties and increase tensile strength. The cable achieves elasticity and tensile strength beyond conventional standards through the FRP-made wire covering units.

Elimination of the need for moisture-proof tape is another noteworthy aspect, as the impermeability of FRP to water obviates the necessity for additional measures. Given the high FRP percentage in the cable, tensile strength is predominantly provided by FRP, surpassing standard requirements, and rendering the addition of aramid fibers unnecessary.

The present invention significantly reduces the costs associated with optical cable installation operations. The reduction in cable diameter, and subsequently, the diameter of ground ducts used for cabling, leads to diminished transportation costs for cables and ducts, decreased drilling costs, and reduced expenses for the repair and reconstruction of drilled routes.

Furthermore, the invention reduces cable diameter and the number of elements within the cable, resulting in a substantial decrease in weight per length unit of cable. This reduction enhances the capacity of aerial ducts with high weight limits.

The invention increases the cable's blowing capabilities over much longer distances compared to conventional cables in aerial and ground ducts, thereby reducing network development and maintenance costs.

Additionally, the invention diminishes drilling volume, cable and duct weight, and the volume and space requirements of drilling and transportation equipment. Consequently, the reduced staff requirements for the executive group enable optical cable installation in busy roads and narrow passages.

Manufacturing cables utilizing optical composite units opens up a range of versatile applications:
a) Micro Optical Cable for Air Blowing: The low diameter and high elasticity of cables produced with composite units make them ideal for micro cables, particularly suited for air-blowing applications. This innovative approach ensures efficient and reliable micro cable production.
b) Production of Duct Optical Cables: The reduced diameter and high tensile strength, crucial for duct cables during installation, coupled with increased capacity for fixed diameter cables, result in robust duct cables with enhanced strength and capacity.
c) Production of Direct Burial Optical Cables: The capability to withstand high cross-sectional pressure, combined with a low cable diameter, enables the production of exceptionally durable cables at a significantly lower installation cost, showcasing the innovative potential.
d) Drop Optical Cable Production: The very low diameter, high tensile strength, and impact resistance achieved through the proposed innovation contribute to heightened reliability and extended service life in the production of drop optical cables.
e) Production of Optical Cables for Indoor Installation (Indoor Cable): The very low diameter and exceptional elasticity of cables produced with this innovation significantly enhance cable efficiency for installations in confined spaces, offering practical solutions for indoor installations.
f) Production of Tactical Optical Cables with Special Applications (Tactical Optical Cable): The extremely small diameter, combined with outstanding physical parameters (such as high tensile strength, pressure tolerance, impact resistance, and a wide temperature range), along with low weight and easy transport, makes tactical optical cables a feasible application. The high elastic modulus prevents twisting and knotting, ensuring reliability in various scenarios. The homogeneity of the cable, achieved through stress release along the cable, allows for the production of diverse tactical cables tailored to specific applications, meeting all required technical specifications. The proposed innovation proves invaluable for creating tactical cables designed for special or specific uses.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function, and manner of operation, assembly, and use are deemed readily apparent and obvious to those skilled in the art, and all equivalent relationships to those illustrated in the drawings and described in the specification are intended to be encompassed by the present invention.

1) A method for producing an optical fiber unit comprising the steps of:
a) coating a plurality of optical fibers with colored UV-cured silicone or acrylic resin;
b) placing at least an optical fiber of the plurality of optical fibers that are coated by colored silicone or acrylic resin in a UV-cured fiber-reinforced polymer (FRP) and producing an optical composite unit (OCU), wherein each optical fiber is completely or partially embedded in FRP;
c) coating the optical composite unit (OCU) with one or more layers of polymer, and
d) combining one or more optical composite units (OCU) coated with the one or more layers of polymer to build an optical fiber unit.

2) The method of claim 1, wherein the fiber-reinforced polymer (FRP) is produced in a pultrusion production process and cured by UV radiation.

3) The method of claim 1, wherein the one or more layers of polymer is selected from a group consisting of PVC, Polyamide, Polyurethane, Polyethylene, or any other thermoplastics.

4) The method of claim 1, wherein an outer diameter of each optical fiber coated with colored silicone acrylic resin is 180-250 microns, depending on the type of optical fiber and the mechanical property that is needed.

5) The method of claim 1, wherein the fiber-reinforced polymer (FRP) is selected from a group consisting of Vinyl Ester, Polyester, and Epoxy.

6) The method of claim 1, wherein the fiber-reinforced polymer (FRP) is made of reinforced fiber selected from a group consisting of glass fiber, carbon fiber, aramid fiber and basalt fiber.

7) The method of claim 1, wherein the thickness of the coated layer of polymers is in the range of at least 0.01 mm to 20 mm, depending on the mechanical property that is needed for the optical composite unit (OCU).

8) The method of claim 1, wherein the optical fiber unit is constructed by at least 1 to 24 optical composite units (OCU) depending on the capacity and the mechanical characteristics of the optical fiber unit that is needed.

9) The method of claim 1, wherein the shape of the FRP is circular, oval or a regular polygon.

10) An optical fiber unit, comprising:
an outer plastic coating;
one or more optical composite units (OCU) each coated with a layer of polymer, comprising:
an inner UV-cured fiber-reinforced polymer (FRP);
a plurality of optical fibers coated by colored silicone or acrylic resin and placed in the UV-cured fiber-reinforced polymer (FRP), wherein the plurality of optical fibers are arranged concentrically inside the FRP, and wherein each of the plurality of the optical fibers are completely or partially embedded in the FRP.

11) The optical fiber unit of claim 10, wherein the fiber-reinforced polymer (FRP) is produced in a pultrusion production process and cured by UV radiation.

12) The optical fiber unit of claim 10, wherein the one or more layers of polymer is selected from a group consisting of PVC, Polyamide, Polyurethane, Polyethylene, or any other thermoplastics.

13) The optical fiber of claim 10, wherein an outer diameter of each optical fiber coated with colored silicone acrylic resin is 180-250 microns, depending on the type of optical fiber and the mechanical property that is needed.

14) The optical fiber of claim 10, wherein the fiber-reinforced polymer (FRP) is selected from a group consisting of Vinyl Ester, Polyester, and Epoxy.

15) The optical fiber of claim 10, wherein the fiber-reinforced polymer (FRP) is made of reinforced fiber selected from a group consisting of glass fiber, carbon fiber, aramid fiber and basalt fiber.

16) The optical fiber of claim 10, wherein the thickness of the coated layer of polymers is in the range of at least 0.01 mm to 20 mm, depending on the mechanical property that is needed for the optical composite unit (OCU).

17) The optical fiber of claim 10, wherein the optical fiber unit is constructed by at least 1 to 24 optical composite units (OCU) depending on the capacity and the mechanical characteristics of the optical fiber unit that is needed.

18) The optical fiber of claim 10, wherein the shape of the FRP is circular, oval or a regular polygon.
